(19) United States
(12) Patent Application Publication
(10) Pub. No.: US 2026/0103053 A1
(43) Pub. Date: Apr. 16, 2026

(54) IN-VEHICLE AIR CONDITIONING DEVICE

(71) Applicant: TOYOTA JIDOSHA KABUSHIKI KAISHA, Toyota-shi (JP)

(72) Inventor: Akira TSUCHIYA, Seto-shi (JP)

(73) Assignee: TOYOTA JIDOSHA KABUSHIKI KAISHA, Toyota-shi (JP)

(21) Appl. No.: 19/237,177

(22) Filed: Jun. 13, 2025

(30) Foreign Application Priority Data
Oct. 11, 2024 (JP) 2024-178602

(51) Int. Cl. B60H 1/32

(52) U.S. Cl. CPC B60H 1/32284

(57) ABSTRACT

An in-vehicle air conditioning device includes a refrigerant circuit and first and second cooling liquid circuits. The refrigerant circuit includes a compressor, a condenser for heat dissipation, an expansion valve, and an evaporator for heat absorption, and circulates a hydrocarbon-based refrigerant. A first heat exchanger is integrated with the condenser, and transfers heat from the refrigerant in the condenser to a first cooling liquid. A first cooling liquid circuit includes a radiator, and circulates the first cooling liquid. A second heat exchanger is integrated with the evaporator, and cools a second cooling liquid with the refrigerant in the evaporator. A second cooling liquid circuit circulates the second cooling liquid to supply it to a cooler core. The cooler core is disposed in an air passage of an air conditioning unit. The in-vehicle air conditioning device includes a case housing the refrigerant circuit and the first and second heat exchangers.

### CROSS-REFERENCE TO RELATED APPLICATION

This application claims priority to Japanese Patent Application No. 2024-178602 filed on Oct. 11, 2024, incorporated herein by reference in its entirety.

### BACKGROUND

### 1. Technical Field

The present specification relates to in-vehicle air conditioning devices. More particularly, the present specification discloses an in-vehicle air conditioning device that uses a hydrocarbon-based refrigerant.

### 2. Description of Related Art

In recent years, it has been considered to use hydrocarbon-based refrigerants (HC-based refrigerants) such as propane with a low global warming potential as refrigerants for air conditioning devices. Since HC-based refrigerants are flammable, configurations for preventing refrigerant leaks beforehand, configurations for ensuring safety in the event of a refrigerant leak, etc. have been considered.

Japanese Unexamined Patent Application Publication No. 2007-62683 (JP 2007-62683A) discloses the use of propane as a refrigerant for a vehicle air conditioning device. The air conditioning device of JP 2007-62683 A is configured such that a refrigeration circuit is placed inside an engine compartment, the engine compartment and a vehicle cabin are separated from each other by a partition wall, and the cooling capacity of the refrigeration circuit is transferred to the vehicle cabin via a heat pipe passing through the partition wall. With this configuration, even if there is a refrigerant leak from the refrigeration circuit, the refrigerant does not flow into the vehicle cabin.

### SUMMARY

In in-vehicle air conditioning devices, it is desired to isolate a refrigerant circuit for a hydrocarbon-based refrigerant from other components of a vehicle body to enhance vehicle safety.

The present specification discloses an in-vehicle air conditioning device in which a refrigerant circuit for a hydrocarbon-based refrigerant is isolated from other components of a vehicle body.

An in-vehicle air conditioning device disclosed in the present specification includes:
a refrigerant circuit including a compressor, a condenser for heat dissipation, an expansion valve, and an evaporator for heat absorption and configured such that a hydrocarbon-based refrigerant circulates in the refrigerant circuit;
a first heat exchanger integrated with the condenser of the refrigerant circuit and configured to transfer heat from the refrigerant in the condenser to a first cooling liquid;
a first cooling liquid circuit including a radiator and configured such that the first cooling liquid circulates in the first cooling liquid circuit;
a second heat exchanger integrated with the evaporator of the refrigerant circuit and configured to cool a second cooling liquid by the refrigerant in the evaporator;
a second cooling liquid circuit including a cooler core and configured such that the second cooling liquid circulates in the second cooling liquid circuit;
an air conditioning unit including an air passage in which the cooler core is disposed, and configured to cool air passing through the air passage and blow the air into a vehicle cabin; and
a case in which the refrigerant circuit, the first heat exchanger, and the second heat exchanger are housed.

With this configuration, the refrigerant circuit dissipates heat to the first cooling liquid in the first cooling liquid circuit and absorbs heat from the second cooling liquid in the second cooling liquid circuit. Therefore, the refrigerant circuit can be concentrated in a relatively small area in a vehicle, and the refrigerant circuit and the first and second heat exchangers can be housed in the case. Since the refrigerant circuit and the first and second heat exchangers are housed in the case, the refrigerant circuit and the first and second heat exchangers can be isolated from other components of a vehicle body. Even if there is a refrigerant leak from the refrigerant circuit, the refrigerant is less likely to flow out to other components of the vehicle body. Moreover, the case can protect the refrigerant circuit in the event of a vehicle collision.

In the in-vehicle air conditioning device of the present disclosure, the case may have a heat-shielding property.

With this configuration, the case blocks radiant heat from outside the case. This can reduce heating of the refrigerant circuit by this heat.

In the in-vehicle air conditioning device of the present disclosure, the vehicle may include a drive unit including a power source, the case may be disposed adjacent to the drive unit, and the case may have a heat-shielding property at least on the side facing the drive unit.

With this configuration, the case blocks radiant heat from the drive unit. This can reduce heating of the refrigerant circuit by this heat.

In the in-vehicle air conditioning device of the present disclosure, a bottom wall of the case may have a hole, and a hose extending downward in an up-down direction of the vehicle may be connected to the hole of the case.

This configuration allows the refrigerant to be guided downward in the up-down direction of the vehicle through the hose in the event of a refrigerant leak from the refrigerant circuit.

In the in-vehicle air conditioning device of the present disclosure, the bottom wall of the case may include an inclined surface that slopes downward toward the hole of the case.

This configuration allows the refrigerant to smoothly flow into the hole in the bottom wall of the case in the event of a refrigerant leak from the refrigerant circuit.

In the in-vehicle air conditioning device of the present disclosure, the hydrocarbon-based refrigerant may be propane or a refrigerant mainly containing propane.

A vehicle disclosed in the present specification includes the in-vehicle air conditioning device described above.

With the technique disclosed in the present specification, a refrigerant circuit for a hydrocarbon-based refrigerant can be isolated from other components of a vehicle body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing the configuration of an air conditioning device;

FIG. 2 is a schematic diagram showing arrangement of an air conditioning device in a vehicle;

FIG. 3 is a perspective view for explaining a position of a case of a refrigerant module in a vehicle;

FIG. 4 is an exploded perspective view of a case of a refrigerant module;

FIG. 5 is a perspective view showing a refrigerant module housed in a case body;

FIG. 6A is a cross-sectional view showing a cross-section of the case of the refrigerant module;

FIG. 6B is a cross-sectional view showing another cross-section of the case of the refrigerant module; and

FIG. 7 is a schematic diagram showing the configuration of another air conditioning device.

### DETAILED DESCRIPTION OF EMBODIMENTS

### Introduction

Hereinafter, embodiments will be described with reference to the drawings. In all the drawings, equivalent components are denoted by the same reference numerals, and redundant description will be omitted. In the following description, unless otherwise specified, the terms indicating the front-rear, right-left, and up-down, etc. directions indicate the directions related to a vehicle. In each figure, the direction of the arrow FR indicates a forward direction, the direction of the arrow UP indicates an upward direction, and the direction of the arrow LH indicates a leftward direction.

The air conditioning device is mounted on a vehicle such as an automobile. In the embodiments described below, the type of the vehicle on which the air conditioning device is mounted is not limited. For example, the vehicle may be an engine vehicle using an engine as a power source, or a battery electric vehicle using a motor as a power source. The vehicle may be a hybrid battery electric vehicle or a plug-in hybrid battery electric vehicle equipped with both an engine and a motor. The vehicle may be a fuel cell electric vehicle equipped with fuel cells, or may be a battery electric vehicle that runs with electric power stored in a battery.

The air conditioning device includes a refrigerant circuit in which a hydrocarbon-based refrigerant (referred to as HC-based refrigerant) circulates. The HC-based refrigerant is flammable. Examples of the HC-based refrigerant include propane, butane, isobutane, ethane, ethylene, and propylene. One of these HC-based refrigerants or a mixture of two or more of these HC-based refrigerants may be used in the refrigerant circuit. A mixed refrigerant mainly containing one or more HC-based refrigerants and further containing a refrigerant other than HC-based refrigerants, various additives, etc. may be used in the refrigerant circuit. For example, in the refrigerant circuit, propane or a refrigerant mainly containing propane and further containing at least one of another refrigerant and an additive (refrigerant mainly containing propane) may be used. The HC-based refrigerant may be R290 as an example. In the present specification, the hydrocarbon-based refrigerant (HC-based refrigerant) means a pure hydrocarbon-based refrigerant or a refrigerant mainly containing a hydrocarbon-based refrigerant.

The refrigerant circuit serves as a heat source of the air conditioning device. The refrigerant circuit includes, in order along the flow direction of the refrigerant, a compressor, a condenser for heat dissipation, an expansion valve, and an evaporator for heat absorption. A receiver may be provided between the condenser and the expansion valve. An accumulator may be provided between the evaporator and the compressor.

The air conditioning device may include a high-temperature cooling liquid circuit in which the cooling liquid heated by the condenser of the refrigerant circuit circulates, and a low-temperature cooling liquid circuit in which the cooling liquid cooled by the evaporator of the refrigerant circuit circulates. The cooling liquid is a heat medium, and the high-temperature cooling liquid circuit and the low-temperature cooling liquid circuit are each a heat medium circuit.

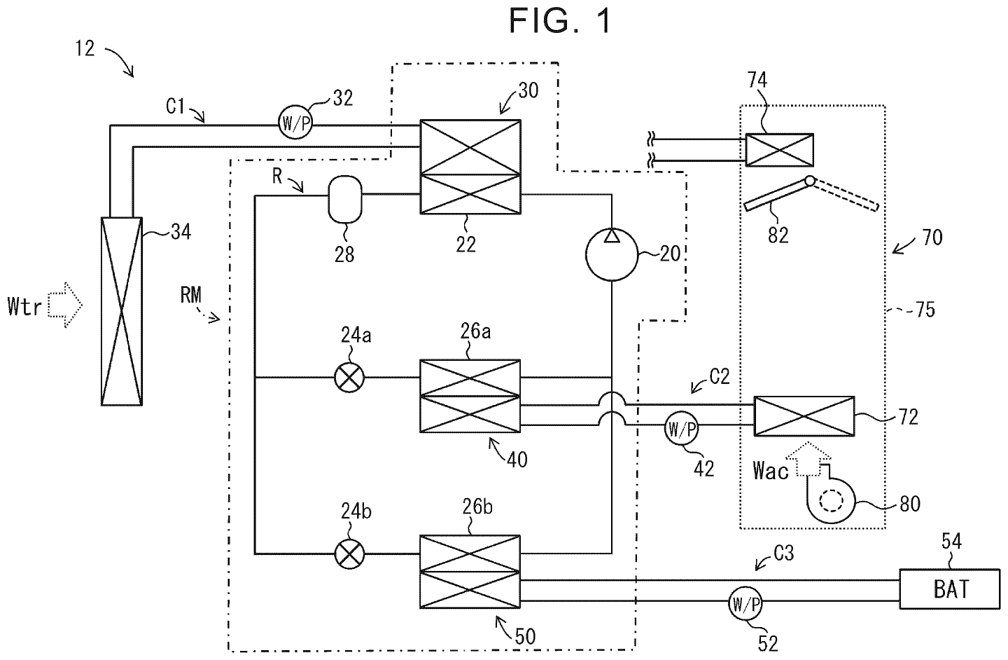

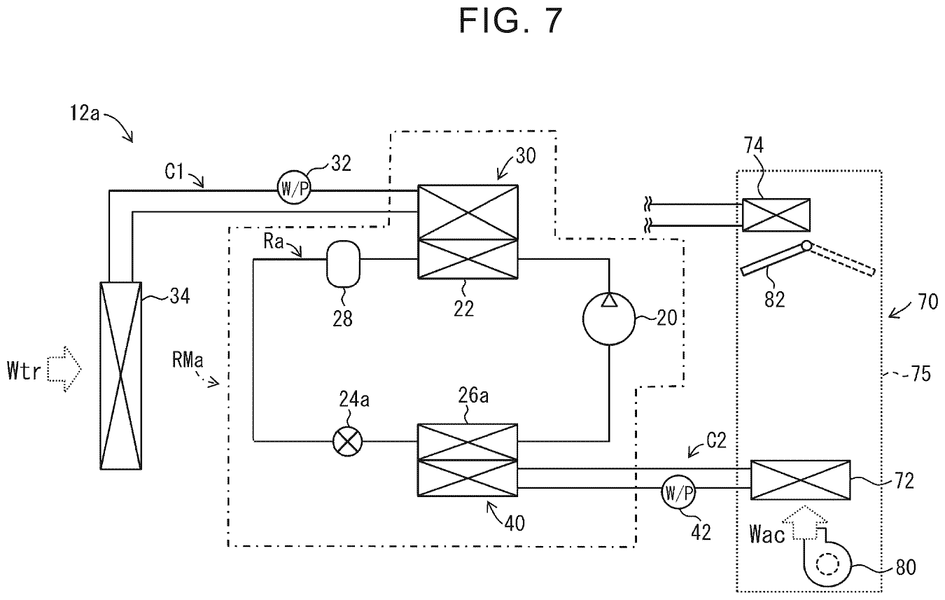

In the embodiment described below, as shown in FIG. 1, the air conditioning device 12 includes a first cooling liquid circuit C1 as a high-temperature cooling liquid circuit and second and third cooling liquid circuits C2, C3 as a low-temperature cooling liquid circuit. Note that the air conditioning device 12 can be configured without the third cooling liquid circuit C3, which will be described with reference to FIG. 7.

The cooling liquid in the first to third cooling liquid circuits C1, C2, C3 may be coolant. That is, the cooling liquid may be water containing no additive, water containing an additive such as an antifreeze agent or an antiseptic, or a coolant liquid. Further, a liquid heat medium such as oil may be employed as the cooling liquid, and is not limited thereto.

In the embodiments described below, the refrigerant circuit is located below the front hood of the vehicle. Hereinafter, the area under the front hood is referred to as an “engine compartment” regardless of the presence or absence of a power source (an engine, a motor, etc.) under the front hood and the type of the power source.

### Embodiment

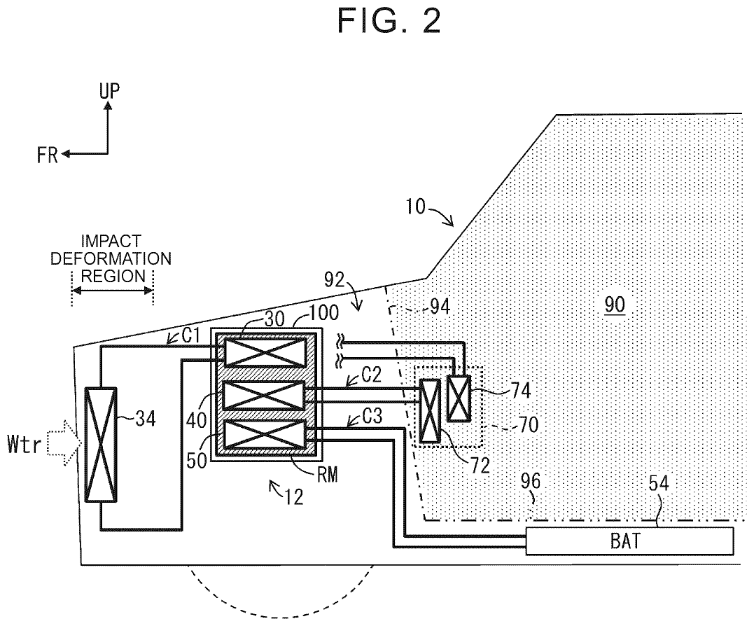

FIG. 1 is a schematic diagram illustrating a configuration of an air conditioning device 12 according to an embodiment. FIG. 2 is a schematic diagram showing the arrangement of the air conditioning device 12 in the vehicle. The vehicle 10 includes a battery 54 that supplies electric power to a motor as a power source. The vehicle 10 may be, for example, a battery electric vehicle, a hybrid battery electric vehicle, a plug-in hybrid battery electric vehicle, etc.

The air conditioning device 12 performs air conditioning in the vehicle cabin 90 and cools the battery 54. Note that the air conditioning device 12 may be configured to cool an in-vehicle device such as a PCU (Power Control Unit) together with the battery 54 or instead of the battery 54.

As shown in FIG. 1, the air conditioning device 12 includes a refrigerant circuit R serving as a heat source, first to third cooling liquid circuits C1, C2, C3, and an air conditioning unit 70. The first cooling liquid heated by the refrigerant in the refrigerant circuit R circulates in the first cooling liquid circuit C1. The second cooling liquid cooled by the refrigerant in the refrigerant circuit R circulates in the second cooling liquid circuit C2. Similarly, the third cooling liquid cooled by the refrigerant in the refrigerant circuit R circulates in the third cooling liquid circuit C3. The air conditioning unit 70 supplies the air cooled by the second cooling liquid circulating in the second cooling liquid circuit C2 to the vehicle cabin.

The refrigerant circuit R is a closed circuit in which the compressor 20, the condenser 22, the receiver 28, the expansion valves 24a, 24b, and the evaporators 26a, 26b are connected to each other by a refrigerant pipe in order to circulate a HC-based refrigerant (hereinafter sometimes simply referred to as refrigerant). The expansion valve 24a and the evaporator 26a are connected in series, and similarly the expansion valve 24b and the evaporator 26b are connected in series. The expansion valve 24a, the refrigerant channel of the evaporator 26a, and the refrigerant channel of the expansion valve 24b and the evaporator 26b are connected in parallel.

The air conditioning device 12 includes a heat exchanger 30. The heat exchanger 30 is integrated with the condenser 22 of the refrigerant circuit R, and exchanges heat between the refrigerant in the refrigerant circuit R and the first cooling liquid in the first cooling liquid circuit C1. The heat exchanger 30 is a water-cooled condenser, and may be, for example, a plate heat exchanger. The heat exchanger 30 is a first heat exchanger.

The first cooling liquid circuit C1 is a closed circuit in which the water pump 32, the heat exchanger 30, and the radiator 34 are sequentially connected by cooling liquid pipes to circulate the first cooling liquid. The radiator 34 is a heat exchanger that exchanges heat between the first cooling liquid and the vehicle traveling wind Wtr. In the first cooling liquid circuit C1, the first cooling liquid pumped by the water pump 32 is heated to a high temperature by the heat dissipation of the refrigerant in the condenser 22 in the refrigerant circuit R while passing through the heat exchanger 30. The first cooling liquid that has become hot is sent to the radiator 34, where it is cooled by the vehicle traveling wind Wtr.

The air conditioning device 12 includes a heat exchanger 40. The heat exchanger 40 is integrated with the evaporator 26a of the refrigerant circuit R, and exchanges heat between the refrigerant in the refrigerant circuit R and the second cooling liquid in the second cooling liquid circuit C2. The heat exchanger 40 may be, for example, a plate heat exchanger. The heat exchanger 40 is a second heat exchanger.

The second cooling liquid circuit C2 is a closed circuit in which the water pump 42, the heat exchanger 40, and the cooler core 72 are sequentially connected by cooling liquid pipes to circulate the second cooling liquid. The cooler core 72 is a heat exchanger that is disposed in the air passage 75 of the air conditioning unit 70 and exchanges heat between the second cooling liquid and the air conditioning airflow Wac. In the second cooling liquid circuit C2, the second cooling liquid pumped by the water pump 42 becomes a low temperature due to the heat absorption of the refrigerant at the evaporator 26a in the refrigerant circuit R while passing through the heat exchanger 40. The second cooling liquid having reached the low temperature is sent to the cooler core 72, where it cools the air conditioning airflow Wac.

Further, the air conditioning device 12 includes a heat exchanger 50. The heat exchanger 50 is integrated with the evaporator 26b of the refrigerant circuit R, and exchanges heat between the refrigerant in the refrigerant circuit R and the third cooling liquid in the third cooling liquid circuit C3. The heat exchanger 50 may be, for example, a plate heat exchanger. The heat exchanger 50 is a third heat exchanger.

The third cooling liquid circuit C3 is a closed circuit in which the water pump 52, the heat exchanger 50, and the battery 54 are sequentially connected by cooling liquid pipes to circulate the third cooling liquid. In the third cooling liquid circuit C3, the cooling liquid pumped by the water pump 52 becomes a low temperature due to the heat absorption of the refrigerant at the evaporator 26b in the refrigerant circuit R while passing through the heat exchanger 50. The third cooling liquid having reached the low temperature is sent to the battery 54 to cool the battery 54. In this specification, the third cooling liquid circuit C3 and the third cooling liquid are also referred to as battery cooling liquid circuit and battery cooling liquid, respectively.

In this specification, the expansion valve 24a, the evaporator 26a, and the heat exchanger 40 are also referred to as an air conditioning expansion valve, an air conditioning evaporator, and an air conditioning heat exchanger, respectively. The expansion valve 24b, the evaporator 26b, and the heat exchanger 50 are also referred to as a battery expansion valve, a battery evaporator, and a battery heat exchanger, respectively.

In the refrigerant circuit R, the refrigerant circulates as follows. The compressor 20 discharges a high-pressure gas refrigerant, the gas refrigerant is liquefied condensed by heat exchange with the first cooling liquid of the first cooling liquid circuit C1 passing through the heat exchanger 30 in the condenser 22, and becomes a high-pressure liquid refrigerant. The high-pressure liquid refrigerant flowing out of the condenser 22 is decompressed and expanded by the expansion valve 24a via the receiver 28, becomes a low-pressure refrigerant, and flows into the evaporator 26a. The low-pressure refrigerant flowing into the evaporator 26a is evaporated by heat exchange with the second cooling liquid in the second cooling liquid circuit C2 passing through the heat exchanger 40 at the evaporator 26a, becomes a gaseous refrigerant, flows out the evaporator 26a, and returns to the compressor 20.

The high-pressure liquid refrigerant flowing out of the condenser 22 is decompressed and expanded by the expansion valve 24b via the receiver 28, becomes a low-pressure refrigerant, and flows into the evaporator 26b. The low-pressure refrigerant flowing into the evaporator 26b is evaporated by heat exchange with the third cooling liquid in the third cooling liquid circuit C3 passing through the heat exchanger 50 at the evaporator 26b, becomes a gaseous refrigerant, flows out of the evaporator 26b, and returns to the compressor 20.

The air conditioning unit 70 includes a blower 80 and an air passage 75 formed by a case, not shown. A blower 80, a cooler core 72, and a heater core 74 are arranged in this order from the air flow direction inside the air passage 75. The heater core 74 is, for example, a heat exchanger to which engine coolant or coolant warmed by a water-heating PTC heater is supplied. The heater core 74 may be configured to supply the cooling liquid warmed by the heat exchanger 30.

The blower 80 introduces air into the air passage 75 from an intake port, not shown, and allows the air to pass through the cooler core 72 and the heater core 74, thereby blowing the temperature-controlled air into the vehicle cabin. An air mix door 82 is provided inside the air passage 75, and the air mix door 82 adjusts a ratio at which the air that has passed through the cooler core 72 flows to the heater core 74. Note that the air conditioning unit 70 may employ a conventional technique of HVAC (Heating, Ventilation, and Air Conditioning).

As shown in FIG. 2, the engine compartment 92 and the vehicle cabin 90 are partitioned by a dashboard 94. An instrument panel, not shown, is provided on the vehicle cabin 90 side of the dashboard 94. The air conditioning unit 70 is disposed between the instrument panel and the dashboard 94.

The battery 54 is disposed under the floor of the vehicle cabin 90, that is, under the floor panel 96. It should be noted that the battery 54 may be disposed below the seat, at the rear of the vehicle, or the like, and its position is not limited.

The air conditioning device 12 includes a controller. The controllers may be configured to include a processor and a storage device, e.g., an ECU (Electronic Control Unit). The controller controls devices included in the air conditioning device 12 based on detection information of a plurality of sensors (an outside air temperature, an inside air temperature, a temperature sensor for detecting a battery temperature, a solar radiation amount sensor, a pressure sensor, and the like), setting information of an operation panel operated by a user, and the like. The controller may employ a conventional control technique of an air conditioning device.

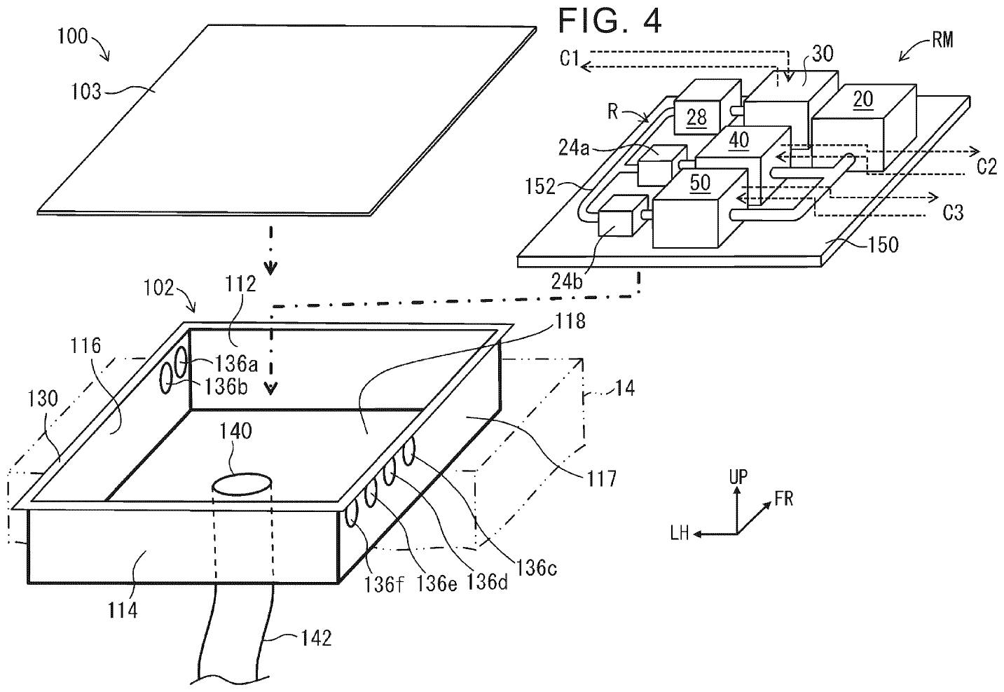

As shown in the upper right of FIG. 4, the refrigerant circuit R is integrated to form a refrigerant module RM. Specifically, the refrigerant module RM is a unit of the air conditioning device 12 in which the devices (components) inside the long dashed short dashed line in FIG. 1 are integrated. As shown in FIG. 4, in the refrigerant module RM, the compressor 20, the first to third heat exchangers 30, 40, 50, the receiver 28, and the two expansion valves 24a, 24b are fixed to the upper surface of the plate 150 by screws or the like. The devices are connected to each other by a refrigerant pipe 152.

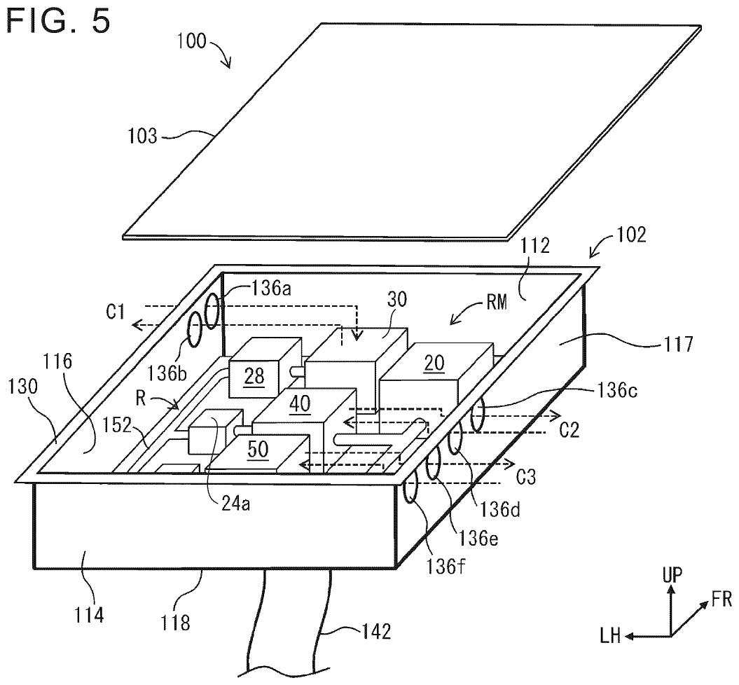

As shown in FIG. 4, the air conditioning device 12 includes a case 100. The case 100 includes a case body 102 and a top panel 103. As shown in FIG. 5, the refrigerant module RM is housed in the case body 102. The refrigerant module RM is fixed to the inner surface of the case body 102 via brackets, not shown. The top panel 103 is attached to the case body 102 so as to cover the case body 102 in which the refrigerant module RM is accommodated.

The case body 102 includes an outer surface having heat-shielding properties. The heat-shielding properties may be obtained by forming the case body 102 itself with a heat shielding material, or may be obtained by providing aluminum vapor deposition, aluminum foil, or the like on the outer surface of the case body 102. As shown in FIG. 4, the case body 102 includes a front wall 112, a rear wall 114, a left side wall 116, a right side wall 117, and a bottom wall 118. The outer surfaces of these walls have heat-shielding properties. The case body 102 includes a flange 130 extending outward at an upper end thereof. The flange 130 has a frame shape in a top view.

As shown in FIG. 5, the left side wall 116 has two through holes 136a, 136b through which the pipe of the first cooling liquid circuit C1 passes. The right side wall 117 has two through holes 136c, 136d through which the pipe of the second cooling liquid circuit C2 passes, and two through holes 136e, 136f through which the pipe of the third cooling liquid circuit C3 passes. Note that the six through holes 136a to 136f may each have a sealing material at the edge portion to prevent a gap from being generated between the outer surface of the pipe.

Note that one or more walls of the case body 102 may have holes (not shown) through which electric wires such as a power line and a control line connected to equipment such as the compressor 20 pass. In addition, a sealing material may be provided at an edge portion of the hole for the electric wire to prevent a gap from being formed between the outer surface of the electric wire.

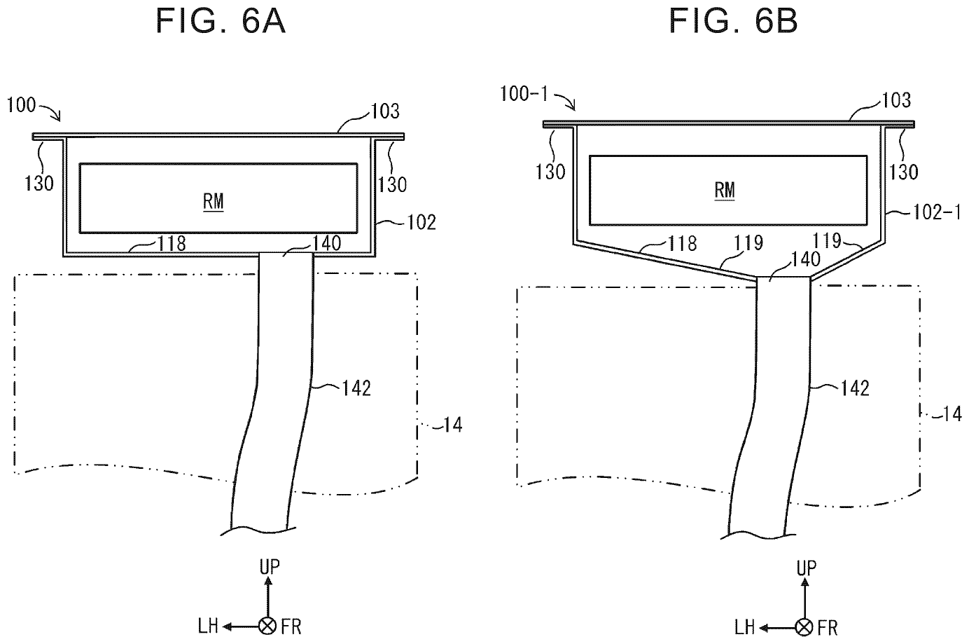

As shown in FIG. 4, the bottom wall 118 of the case body 102 includes a hole 140. A hose 142 extending downward in the up-down direction of the vehicle is connected to the hole 140. FIG. 6A shows a cross-section of the case 100 of the refrigerant module. The hose 142 extends from the hole 140 of the bottom wall 118 to the bottom of the vehicle body. A distal end (not shown) of the hose 142 may be secured to a vehicle body structure located at a lower portion (or bottom) of the engine compartment.

The top panel 103 also includes an outer surface having heat-shielding properties. The heat-shielding properties may be obtained by forming the top panel 103 itself with a heat shielding material, or may be obtained by providing aluminum vapor deposition, aluminum foil, or the like on the outer surface of the top panel 103. The top panel 103 is disposed on the flange 130 of the case body 102. The outer peripheral portion of the top panel 103 is fastened to the flange 130 of the case body 102 by a plurality of screws. For example, screw holes are provided at regular intervals in the outer peripheral portion of the top panel 103 and the flange 130 of the case body 102. A nut is disposed on the lower surface of the flange 130 of the case body 102 so as to correspond to the screw hole. A plurality of external threads is passed from the upper side of the top panel 103 through the aligned screw holes in the top panel 103 and the case body 102, and are screwed into the nuts on the lower surface of the flange 130.

The flange 130 of the case body 102 may have a sealing material on the upper surface to prevent a gap from being formed between the flange and the outer peripheral portion of the top panel 103. Alternatively, the outer peripheral portion of the top panel 103 may have, on the lower surface thereof, a sealing material that prevents a gap from being formed between the case body 102 and the flange 130.

As shown in FIG. 2, the case 100 of the refrigerant module is disposed in the engine compartment 92. The first cooling liquid circuit C1 is disposed in front of the case 100. The case 100 may be disposed behind a collision deformation region in front of the vehicle. This can reduce the collision load applied to the refrigerant module RM (refrigerant circuit R) in the event of a head-on collision of the vehicle 10.

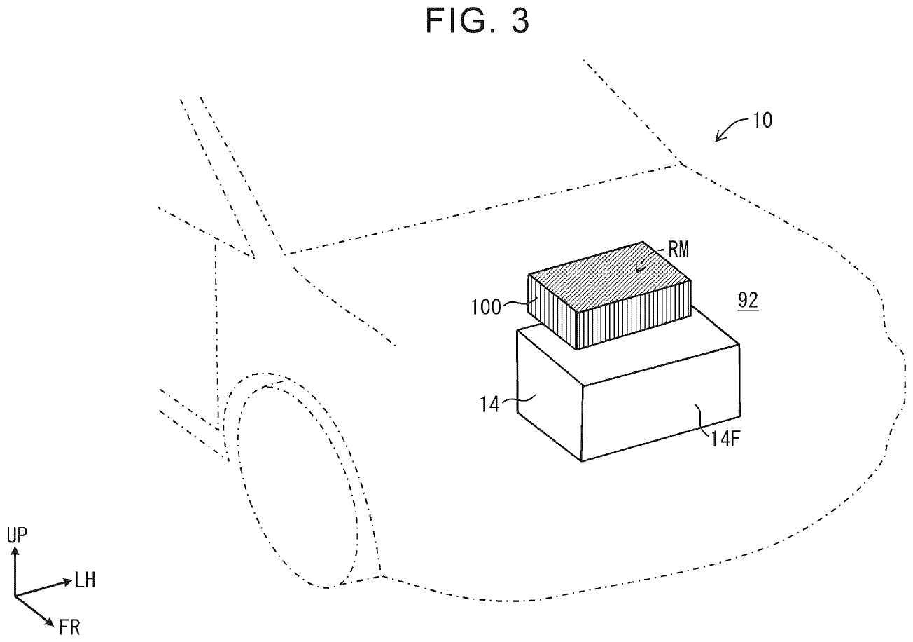

FIG. 3 shows a more specific position of the case 100 of the refrigerant module. The vehicle 10 includes a drive unit 14. The drive unit 14 comprises a power source of the vehicle 10 and a structure integrated therewith. The power source may include an engine, a motor, or both. The drive unit 14 may be, for example, an engine unit, a motor unit, a power train unit including an engine and a transaxle, or an eAxle (e-axle). The drive unit 14 is disposed in the engine compartment 92.

As shown in FIG. 3, the case 100 of the refrigerant module is arranged adjacent to the drive unit 14. Specifically, the case 100 is disposed rearward of the front end 14F of the drive unit 14 and above the drive unit 14. The space behind the front end 14F of the drive unit 14 is protected in the event of a head-on collision of the vehicle 10. Therefore, arranging the case 100 in the space can reduce the collision load that is applied to the refrigerant module RM (refrigerant circuit R) in the event of a head-on collision of the vehicle 10. The case 100 of the refrigerant module may be disposed behind the front end 14F of the drive unit 14 and below the drive unit 14.

Note that FIGS. 4 and 6A also show the drive unit 14. As shown in these figures, the hose 142 of the case 100 is arranged on the rear side of the drive unit 14.

According to the embodiment described above, the refrigerant circuit R dissipates heat to the cooling liquid in the first cooling liquid circuit C1 and absorbs heat from the cooling liquid circuit in the second and third cooling liquid circuits C2, C3. Therefore, the refrigerant circuit R can be concentrated in a relatively small area in the vehicle, and the refrigerant circuit R and the first to third heat exchangers 30, 40, 50 can be housed in the case 100. Since the refrigerant circuit R and the first to third heat exchangers 30, 40, and 50 are housed in the case 100, they can be isolated from other components of the vehicle body. Even if the HC-based refrigerant leaks from the refrigerant circuit R, the HC-based refrigerant is less likely to flow out to other components of the vehicle body. Moreover, the case 100 can protect the refrigerant circuit R in the event of a vehicle collision.

Further, according to the embodiment described above, since the case 100 has heat-shielding properties, radiant heat from the drive unit 14 is shielded, which can reduce heating of the refrigerant circuit R by the heat.

According to the embodiment described above, as shown in FIG. 6A, the bottom wall 118 of the case body 102 has the hole 140, and the hose 142 extending downward in the up-down direction of the vehicle is connected to the hole 140. Therefore, the HC-based refrigerant can be guided downward in the up-down direction of the vehicle through the hose 142 in the event of a leak of the HC-based refrigerant from the refrigerant circuit R. The HC-based refrigerant is generally heavier than air, and therefore flows downward through the hose 142. This allows the HC-based refrigerant to be discharged to a relatively safe location at the bottom of the vehicle body.

### Modifications

FIG. 6B shows a cross-section of another case 100-1 of the refrigerant module. In the case 100-1, the bottom wall 118 of the case body 102-1 has an inclined surface 119 that slopes downward toward the hole 140. The bottom wall 118 slopes downward from the left end and the right end toward the hole 140, and slopes downward from the front end and the rear end toward the hole 140. According to this aspect, the HC-based refrigerant can be smoothly caused to flow into the hole 140 in the event of a leak of the HC-based refrigerant from the refrigerant circuit R.

In the embodiment described above, the case 100, 100-1 has the top panel 103. However, the case 100, 100-1 may be configured without the top panel 103. The top panel 103 may have an opening.

In the embodiment described above, all the walls of the case 100, 100-1 have heat-shielding properties. However, only the side (for example, the bottom wall 118) of the drive unit 14 of the case 100, 100-1 may have heat-shielding properties. The case 100, 100-1 may be disposed adjacent to a heating element other than the drive unit 14. At least the side of the heating element of the case 100, 100-1 may have heat-shielding properties. For example, when there is no heating element such as the drive unit 14 near the case 100, 100-1, the case 100, 100-1 may not have heat-shielding properties. Note that all or part of the case 100, 100-1 may be made of resin or the like.

In the above-described embodiment, the refrigerant circuit R is integrated with the plate 150 to form the refrigerant module RM. However, the refrigerant circuit R may not be integrated by the plate 150 etc. That is, the refrigerant circuit R only needs to be housed in the case 100, 100-1. For example, the plurality of devices constituting the refrigerant circuit R may be individually fixed to the inner surface of the case 100, 100-1.

### Another Air Conditioning Device

Next, another air conditioning device will be described. FIG. 7 is a schematic diagram illustrating a configuration of another air conditioning device 12a. This air conditioning device 12a has a configuration in which the expansion valve 24b, the third heat exchanger 50, and the third cooling liquid circuit C3 are omitted from the air conditioning device 12 (see FIG. 1). The refrigerant circuit Ra of the air conditioning device 12a is configured such that the compressor 20, the condenser 22, the receiver 28, the expansion valve 24a, and the evaporator 26a are sequentially connected by a refrigerant pipe.

The air conditioning device 12a is configured not to cool the battery 54 (see FIG. 1). The battery 54 may be cooled by a cooling device provided separately from the air conditioning device 12a. In addition, in a vehicle such as an engine vehicle that does not have the battery 54 (a battery that supplies electric power to the motor), since a cooling device for the battery is not required, this air conditioning device 12a can be adopted.

In the air conditioning device 12a, the device (component) inside the long dashed short dashed line in FIG. 7 is housed in the case 100, 100-1. These components may be housed in the case 100, 100-1 either in the form of an integrated refrigerant module RMa or in such a manner that the components are individually fixed to the inner surface of the case.

What is claimed is:

1. An in-vehicle air conditioning device comprising:
a refrigerant circuit including a compressor, a condenser for heat dissipation, an expansion valve, and an evaporator for heat absorption, the refrigerant circuit being configured such that a hydrocarbon-based refrigerant circulates in the refrigerant circuit;
a first heat exchanger integrated with the condenser of the refrigerant circuit, the first heat exchanger being configured to transfer heat from the refrigerant in the condenser to a first cooling liquid;
a first cooling liquid circuit including a radiator, the first cooling liquid circuit being configured such that the first cooling liquid circulates in the first cooling liquid circuit;
a second heat exchanger integrated with the evaporator of the refrigerant circuit, the second heat exchanger being configured to cool a second cooling liquid by the refrigerant in the evaporator;
a second cooling liquid circuit including a cooler core, the second cooling liquid circuit being configured such that the second cooling liquid circulates in the second cooling liquid circuit;
an air conditioning unit including an air passage in which the cooler core is disposed, the air conditioning unit being configured to cool air passing through the air passage and blow the air into a vehicle cabin; and
a case in which the refrigerant circuit, the first heat exchanger, and the second heat exchanger are housed.

2. The in-vehicle air conditioning device according to claim 1, wherein the case has a heat-shielding property.

3. The in-vehicle air conditioning device according to claim 1, wherein:
a vehicle includes a drive unit including a power source;
the case is disposed adjacent to the drive unit; and
the case has a heat-shielding property at least on a side facing the drive unit.

4. The in-vehicle air conditioning device according to claim 1, wherein:
a bottom wall of the case has a hole; and
a hose extending downward in an up-down direction of a vehicle is connected to the hole of the case.

5. The in-vehicle air conditioning device according to claim 4, wherein the bottom wall of the case includes an inclined surface that slopes downward toward the hole of the case.
